(19) United States
(12) Patent Application Publication
(10) Pub. No.: US 2014/0047175 A1
(43) Pub. Date: Feb. 13, 2014

(54) IMPLEMENTING EFFICIENT CACHE TAG LOOKUP IN VERY LARGE CACHE SYSTEMS

(71) Applicants: Bulent Abali, Tenafly, NJ (US); Bruce L. Beukema, Hayfield, MN (US); James A. Marcella, Rochester, MN (US); Paul G. Reuland, Rochester, MN (US); Michael M. Tsao, Yorktown Heights, NY (US)

(72) Inventors: Bulent Abali, Tenafly, NJ (US); Bruce L. Beukema, Hayfield, MN (US); James A. Marcella, Rochester, MN (US); Paul G. Reuland, Rochester, MN (US); Michael M. Tsao, Yorktown Heights, NY (US)

(73) Assignee: INTERNATIONAL BUSINESS MACHINES CORPORATION, Armonk, NY (US)

(21) Appl. No.: 13/570,778

(22) Filed: Aug. 9, 2012

(51) Int. Cl. G06F 12/00

(52) U.S. Cl. 711/105; 711/E12.001

(57) ABSTRACT

A method and circuit for implementing a cache directory and efficient cache tag lookup in very large cache systems, and a design structure on which the subject circuit resides are provided. A tag cache includes a fast partial large (LX) cache directory maintained separately on chip apart from a main LX cache directory (LXDIR) stored off chip in dynamic random access memory (DRAM) with large cache data (LXDATA). The tag cache stores most frequently accessed LXDIR tags. The tag cache contains predefined information enabling access to LXDATA directly on tag cache hit with matching address and data present in the LX cache. Only on tag cache misses the LXDIR is accessed to reach LXDATA.

### FIELD OF THE INVENTION

The present invention relates generally to the data processing field, and more particularly, relates to a method and circuit for implementing a cache directory and efficient cache tag lookup in very large cache systems, and a design structure on which the subject circuit resides.

### DESCRIPTION OF THE RELATED ART

Modern computer systems typically are configured with a large amount of memory in order to provide data and instructions to one or more processors in the computer systems. Main memory of the computer system is typically large, often many GB (gigabytes) and is typically implemented in DRAM.

Historically, processor speeds have increased more rapidly than memory access times to large portions of memory, in particular, DRAM memory (Dynamic Random Access Memory). Memory hierarchies have been constructed to reduce the performance mismatches between processors and memory. For example, most modern processors are constructed having an L1 (level 1) cache, constructed of SRAM (Static Random Access Memory) on a processor semiconductor chip. L1 cache is very fast, providing reads and writes in only one, or several cycles of the processor. However, L1 caches, while very fast, are also quite small, perhaps 64 KB (Kilobytes) to 256 KB. An L2 (Level 2) cache is often also implemented on the processor chip. L2 cache is typically also constructed using SRAM storage, although some processors utilize DRAM storage. The L2 cache is typically several times larger in number of bytes than the L1 cache, but is slower to read or write.

Some modern processor chips further contain multiple cache levels Ln cache with the higher number indicating a larger, more distant cache, while still faster than other memory. For example, L5 cache is capable of holding several times more data than the L2 cache. L5 cache is typically constructed with DRAM storage. DRAM cache in some computer systems typically is implemented on a separate chip or chips from the processor, and is coupled to the processor with a memory controller and wiring on a printed wiring board (PWB) or a multi-chip module (MCM).

Main memory typically is coupled to a processor with a memory controller, which may be integrated on the same device as the processor or located separate from the processor, often on the same MCM (multi-chip module) or PWB. The memory controller receives load or read commands and store or write commands from the processor and services those commands, reading data from main memory or writing data to main memory. Typically, the memory controller has one or more queues, for example, read queues and write queues. The read queues and write queues buffer information including one or more of commands, controls, addresses and data; thereby enabling the processor to have multiple requests including read and/or write requests, in process at a given time.

For systems with very large off-chip DRAM based cache memories, the size of the cache directory will get proportionally large. Traditional implementations store the cache directory in on-chip memory allowing quick look-up to determine if a requested cache line resides in the cache and, if so, where is it located.

For systems with very large caches, the size of the cache directory can grow too large to reside in on-chip memory. If the cache directory is held on the chip, the size of the silicon area grows raising the chip cost. Another alternative is to move the cache directory to off-chip memory. In this scenario, the latency to accessing memory is significantly degraded. The chip must make two off-chip accesses for each memory request.

A need exists for a circuit having an efficient and effective mechanism for implementing a cache directory and efficient cache tag lookup in very large cache systems.

### SUMMARY OF THE INVENTION

Principal aspects of the present invention are to provide a method and circuit for implementing a cache directory and efficient cache tag lookup in very large cache systems, and a design structure on which the subject circuit resides. Other important aspects of the present invention are to provide such method, circuit and design structure substantially without negative effects and that overcome many of the disadvantages of prior art arrangements.

In brief, a method and circuit for implementing a cache directory and efficient cache tag lookup in very large cache systems, and a design structure on which the subject circuit resides are provided. A tag cache includes a fast partial large (LX) cache directory maintained separately on chip apart from a main LX cache directory (LXDIR) stored off chip in dynamic random access memory (DRAM) with large cache data (LXDATA). The tag cache stores most frequently accessed LXDIR tags. The tag cache contains predefined information enabling access to LXDATA directly on tag cache hit with matching address and data present in the LX cache. Only on tag cache misses the LXDIR is accessed to reach LXDATA.

In accordance with features of the invention, the LX cache includes many GB (gigabytes) and the tag cache is stored on a memory controller chip coupled to the LX cache. The tag cache speeds up accesses to the LX cache. The LX cache is used as fast front-end storage for larger and slower memory, for example bulk DRAM storage.

In accordance with features of the invention, the LX cache directory has a tag array size significantly larger than the tag cache. The tag cache includes in each entry an address tag and an n bit way number is found pointing to one of the 2**n-ways in LXDATA. The tag cache does not include a data array.

In accordance with features of the invention, the tag cache and the LX cache directory are kept consistent, any LX castouts or invalidations must be reflected back to the tag cache immediately to invalidate a corresponding entry in the tag cache.

In accordance with features of the invention, a miss to the tag cache does not yield any information about the presence of the requested address in LX. The LX cache directory must be accessed to determine if the requested address is an LX hit or a miss.

In accordance with features of the invention, the tag cache stores modified and valid control bits.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1A provides a schematic and block diagram representation illustrating a computer system for implementing a cache directory and efficient cache tag lookup in very large cache systems in accordance with a preferred embodiment;

FIG. 1B provides a schematic and block diagram representation illustrating an example circuit for implementing a cache directory and efficient cache tag lookup in very large cache systems of the computer system of FIG. 1A in accordance with a preferred embodiment;

FIG. 2 illustrates an example address format of addressing which yields 1 terabytes of real address space in accordance with a preferred embodiment;

FIG. 3 illustrates an example address format addressing of the LXDATA array in accordance with a preferred embodiment;

FIG. 4 illustrates an example control bits for each cache line in accordance with a preferred embodiment;

FIG. 5 illustrates example implied mapping from each LXDIR entry to LXDATA entry in accordance with a preferred embodiment;

FIG. 6 illustrates example directory information of multiple sets that fit in to one DRAM access unit in accordance with a preferred embodiment;

FIG. 7 illustrates an example relationship between real address and LXDIR and LXDATA in accordance with a preferred embodiment;

FIG. 8 illustrates an example relationship between an LXDIR entry and a tag cache entry in accordance with a preferred embodiment; and

FIG. 9 is a flow diagram of a design process used in semiconductor design, manufacturing, and/or test.

### DETAILED DESCRIPTION OF THE PREFERRED EMBODIMENTS

In the following detailed description of embodiments of the invention, reference is made to the accompanying drawings, which illustrate example embodiments by which the invention may be practiced. It is to be understood that other embodiments may be utilized and structural changes may be made without departing from the scope of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In accordance with features of the invention, a method and circuits for implementing a cache directory and efficient cache tag lookup in very large cache systems, and a design structure on which the subject circuits reside are provided.

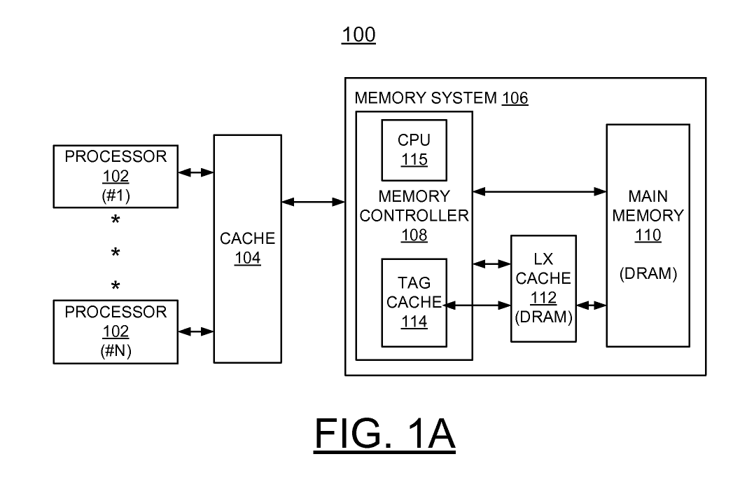

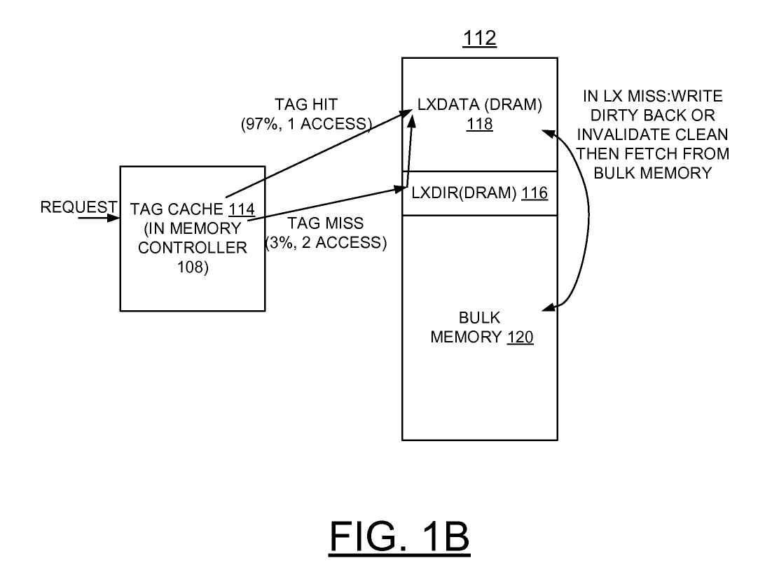

Having reference now to the drawings, in FIG. 1A and 1B, there is shown an example computer system generally designated by the reference character 100 for implementing cache directory and efficient cache tag lookup in very large cache systems in accordance with a preferred embodiment. Computer system 100 includes one or more processors 102 or general-purpose programmable central processing units (CPUs) 102, #1−N. As shown, computer system 100 includes multiple processors 102 typical of a relatively large system; however, system 100 can include a single CPU 102. Computer system 100 includes a cache memory 104 connected to each processor 102.

Computer system 100 includes a memory system 106 including a memory controller 108 in accordance with an embodiment of the invention and a main memory 110. Main memory 110 is a random-access semiconductor memory for storing data, including programs. Main memory 110 is comprised of, for example, a dynamic random access memory (DRAM). Memory system 106 includes a large (LX) cache 112, comprised of dynamic random access memory (DRAM). Memory system 106 includes a tag cache 114 that is a fast partial large (LX) cache directory maintained separately on chip with a central processing unit (CPU) 115 of the memory controller 108 apart from a main LX cache directory (LXDIR) 116 stored off chip in dynamic random access memory (DRAM) LX cache 112 with large cache data (LXDATA) 118. The tag cache 114 stores most frequently accessed LXDIR tags speeding up accesses to the LX cache 112. The tag cache 114 contains predefined information enabling access to LXDATA directly on tag cache hit with matching address and data present in the LX cache 112. Only on tag cache misses the LXDIR is accessed to reach LXDATA.

The LX cache 112 includes many GB (gigabytes) and the tag cache 114 is stored on the memory controller 108 coupled to the LX cache. The LX cache 112 is used as fast front-end storage for a larger and slower memory 120, for example bulk DRAM storage 120.

The LX cache directory LXDIR 116 has a tag array size significantly larger than the tag cache 114. The tag cache 114 includes in each entry an address tag and an n bit way number is found pointing to one of the 2**n-ways in LXDATA. The tag cache 114 does not include a data array.

In accordance with features of the invention, the tag cache 114 and the LX cache directory LXDIR 116 are kept consistent, any LX castouts or invalidations are reflected back to the tag cache 114 immediately to invalidate a corresponding entry in the tag cache.

A miss to the tag cache 114 does not yield any information about the presence of the requested address in LX cached data LXDATA 118. The LX cache directory LXDIR 116 must be accessed to determine if the requested address is an LX hit or a miss.

Memory system 106 is shown in simplified form sufficient for understanding the invention. It should be understood that the present invention is not limited to use with the illustrated memory system 106 of FIG. 1A and 1B.

Tag cache 114 operates strictly as an inclusive cache of LX cache 112. A hit to the tag cache 114 implies that the matching address and data is present in LX cache 112. As a result LX cached data LXDATA 118 can be accessed immediately. A consequence of this policy is that the LX cache directory LXDIR 116 and tag cache 114 must be kept consistent requiring that any LX castouts, invalidations must be reflected back to the tag cache 114 immediately to invalidate the corresponding entry there.

Consider now an example implementation of the LX cache 112 with the following characteristics. LX cache 112 includes, for example, LX line size of 512 bytes in one embodiment. LX cache 112 includes, for example, a 16-way set associative cache. High associativity is expected to perform better on the average and expected to have fewer performance corners cases such as cache thrashing. For example up to 64-way associativity is possible in the current LX cache directory LXDIR 116, depending on the number of bits architected in the LXDIR entries. However, the degree of associativity has some bearing on the size of tag cache 114 as every doubling of associativity adds 1 bit to each tag.

LX cache 112 preferably includes an inclusive cache where inclusive means that data contained in LX cache 112 also can be contained in the main memory 110. Inclusivity reduces the number of bytes exchanged between LX cache 112 and the main memory 110. Therefore, the inclusive LX cache 112 and the organization of bulk memory 120 will have less impact on memory bandwidth utilization. A modified bit per LX line in the LX cache directory LXDIR 116 indicates whether the LX line is clean or modified. Clean lines may be invalidated in LX cache 112 without having to write back to the main memory 110. Therefore bandwidth impact is less.

It is desirable to scrub modified LX lines by writing back to the main memory 110, for example during idle memory cycles. Scrubbing has several benefits including error detection, and performance as LX miss latency is shorter with clean lines. In a simplest implementation, a state machine can walk LX continuously to write modified lines back to memory 110.

LXDATA array 118 is a fixed location in DRAM. Note that LXDATA 118 is not visible in the real address space, and is visible only to the memory controller 108. The following description assumes that the LXDATA array base address is at physical DRAM location 0. It should be understood that other locations are possible by changing the base address, preferably starting at a multiple of LXDATA size.

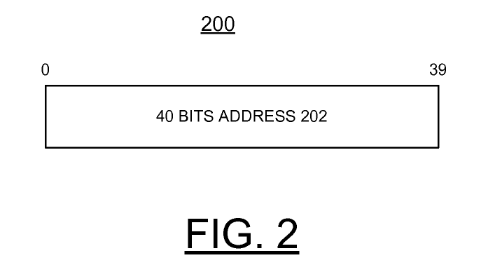

Referring also to FIG. 2, there is shown an example address format of addressing which yields 1 terabytes of real address space generally designated by the reference character 200 in accordance with a preferred embodiment. Address format 200 includes 40 bit real addressing 202, yielding 1 terabytes of real address space. Other address sizes are possible without losing generality.

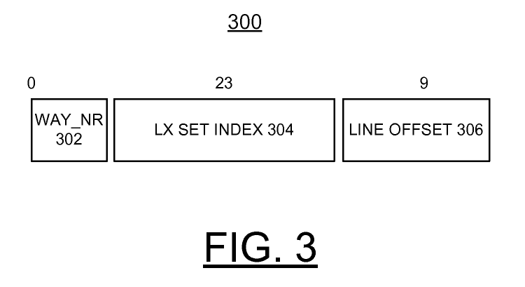

Referring also to FIG. 3, there is shown an example address format generally designated by the reference character 300 addressing of the LXDATA array in accordance with a preferred embodiment. As shown address format 300 includes a way number 302, an LX set index 304, and a line offset 306.

Given are 40-bit address 202, LXDATA 1/16^{th} the size of real address space, 16-way set associativity, and 512 byte line size. Accordingly, the LX set index 304 (one cache congruence class) is determined by a 23-bit offset from the base of the LXDATA array. Within one 16-way set, the cache line is chosen by the 4-bit way number, WayNr 302. Thus, the memory controller 108 can address the required LX line and byte offset within that line using the following mapping: Way Number 302 concatenated with the lower 23+9 bits of the real address is used as the LX set index 304 plus the line offset 306. Upper 4 bits, the WayNr 302, is implied by one of the 16 directory locations in LXDIR, basically the 0 to 15 offset of the tag found in the LX cache directory LXDIR 116. Note that the bits may be permuted to distribute sequential LXDATA locations to different DRAM ranks as needed. For example, WayNr 302 and LX Set Index 304 fields may be swapped.

The LX cache directory LXDIR 116 serves as a tag directory of LX cache 112. LXDIR array physical base address in DRAM can be anywhere. Assuming that the DRAM access unit is 128 bytes, so that in one DRAM read or write operation 128 bytes of data is processed.

In accordance with features of the invention, each cache line in LXDATA 118 is backed by a set of status and control bits and an address tag (CB) in LXDIR 116. CB tag field is used for checking if data for the requested address is present in LXDATA 118.

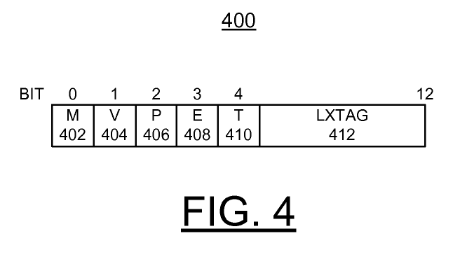

Referring also to FIG. 4, there are shown example control bits generally designated by the reference character 400 for each cache line in accordance with a preferred embodiment. Control Block (CB) 400 includes a Modified bit M 402, a Valid bit V 404, an optional Pinned bit P 406, an Error Bit E 408, a Tagged Bit T 410, and an LX tag 412.

Modified bit M 402 is set to M=1 to indicate that the respective cache line in LXDATA is longer identical to its main memory copy. The M=1 will be typically set when LX line is written. However, note that since Tag cache is caching the address tags, the Tag cache M bit may not be reflected to the LXDIR copy of the M bit immediately, this is assuming Tag cache functions as a write-back cache. M=0 is an indication that the cache line may be dropped during cache replacement and that it is not necessary to write it back to the main memory.

Valid bit V 404 is set Valid bit V=1 to indicate that the LXDIR tag is valid, and that the respective cache line in LXDATA contains valid data. If LX cache line is invalidated, then V=0 is set. An invalid line is the first candidate to install during miss processing. With a single valid bit 404 per 512 byte line, a partial write of a 128 B to an invalid line is not possible. A write miss of 128 B requires installing the 512 B line first from main memory. Optionally, 4 valid bits per 128 B sector in the 512 B may be used. However, if less than 4 valid bits are set; it may be still require fetching the 512 B from main memory and merging with the valid sectors in LX cache 112.

Pinned bit P 406 is a performance enhancement. Pinned bit P 406 serves to lock critical cache lines in LX cache 112, therefore never causing a miss for the particular addresses. When P=1 is set, the respective cache line in LX cache 112 will not participate in the LX replacement decisions. P=1 lines will stay resident in LX until P=0.

Memory controller 108 implements a programming interface through which the software for example the hypervisor can issue a real memory address to pin in LX cache. Memory controller 108 should atomically make the requested cache line present in LX cache 112 and at the same time setting P=1. When pin request is made, hardware must check to prevent pinning of more than half (8) of the lines in a 16-way set. Pinning many or all the lines in a set may cause performance, or operational problems.

Error Bit E 408 of E=1 is an indication that the respective cache line slot in LXDATA array contains a permanent Uncorrectable Error (UE). When E=1 is set, the respective cache slot in LXDATA will not participate in the cache replacement decisions so as to avoid using the marked UE location. When E=1 is set in CB(i), one of 16 implied locations in LXDATA array set <LX set index> has a UE and should not be used further. Tag bits are “don't care” as well as the CB bits except the E bit 408. Memory controller 108 facilitates setting or resetting of the E bit depending on the nature of the error and recovery. Firmware may request memory controller 108 to set the E bit 408 during error recovery. LXDIR 116 may be used to track bad main memory locations, not the LXDATA array 118.

In one embodiment, the LXDATA 118 becomes alternative main memory location for the data, therefore avoiding the bad address in the main memory 110. This has the disadvantage that if too many errors are accumulated in main memory 110, some LX sets associativity reduces to too few and a large fraction of the cache serves as a backup memory. Since LXDATA 119 is the backup data location, it will never be evicted from the cache. And the tag will always match, and this is generally identical to use the Pinned bit 406.

In another embodiment, an array of spare memory locations exist in the main memory 110. The spare memory locations are content addressable; address and data are stored together. For example, the bad address is hashed to a spare location H(addr)=haddr. If the haddr.addr matches addr then it is the backup location for addr and therefore haddr.data may be accessed. If the haddr.addr does not match addr, then sequentially and incrementally search for addr in the spare array starting from haddr. Latency impact of redirection to spare locations is reduced due to caching of data in LX. The primary location is assumed to return an error indication on future access. Otherwise, a line with the MME=1 should not be castout from LX cache 112. If the bad address data is not in LX cache 112, accessing the primary location is expected return an error. Then the alternate location will be searched and then cached in LX cache 112 for subsequent use.

Tagged Bit T 410 is optional. If LXDIR 116 is tracking the contents of the tag cache 114, the T bit 410 may be used to indicate the tracking status of the LX line in the tag cache 114. If an LX line's tag is known not to be in tag cache 112, then it is not necessary to look for and invalidate the respective line in the tag cache. This may reduce the tag cache bandwidth requirements. The T bit 410 may also be useful to the LX replacement policy. A line being in Tag cache 114 is a strong indication of most recent usage. If a line is known not to be in tag cache 114, it may be chosen over the lines in tag cache while evicting lines from LX cache 112.

LX Tag 410 is the address tag of the cache line stored in LX tag. Tag length is 8 bits. LX size is 1/16^{th} of real address space and LX cache 112 is a 16-way associative cache. This requires 4+4=8 bits long address tag 410 in LXDIR.

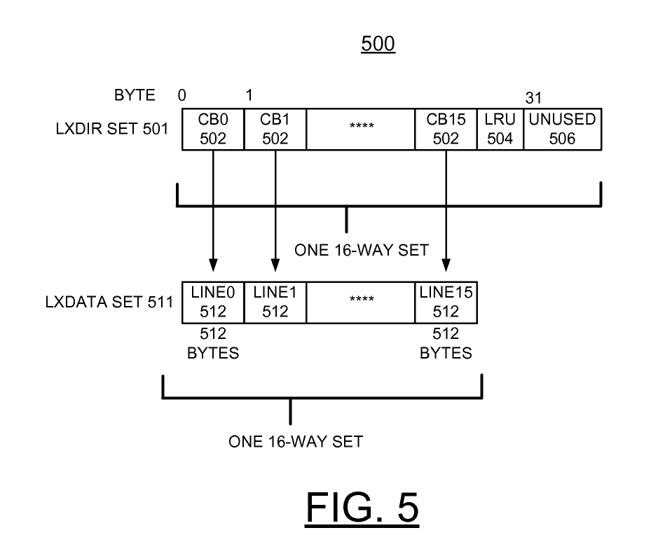

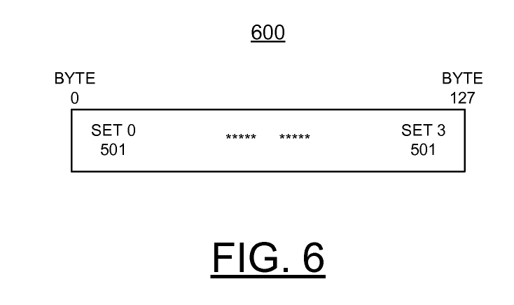

Referring also to FIG. 5, there is shown example implied mapping generally designated by the reference character 500 from each LXDIR entry to LXDATA entry in accordance with a preferred embodiment. Mapping 500 for a 16-way set associative LX cache 112, an LXDIR Set 501 includes a set of 16 CBs 0-15, 502 that are grouped together with a least recently used (LRU) 504, and unused 506 forming the LX DIR Set 501, as shown in FIG. 5. An LXDATA Set 511 includes one 16-way set of LINE 0-15, 512, each including 512 bytes. The LXDIR Set 501 fits in one DRAM access unit. This is so that the directory may be accessed in 1 DRAM read and write. Actually, four LXDIR Sets 501 fit in one DRAM access unit of 128 bytes as shown in FIG. 6.

Referring also to FIG. 6, there is shown example directory information generally designated by the reference character 600 of multiple sets that fit in to one DRAM access unit in accordance with a preferred embodiment. Directory information 600 includes four LXDIR Sets 501 in one DRAM access unit of 128 bytes of BYTE 0-127, as shown. LXDIR size is 1/2048^{th} the size of the physical DRAM. For example, 13 bits have been budgeted for each 512 byte line in the CB. Rounding this to the next byte boundary we get 2 bytes of control information per 512 byte line. LXDATA size is ⅛^{th} the physical DRAM size. Therefore LXDIR size is 2/512/8= 1/2048^{th} of DRAM size.

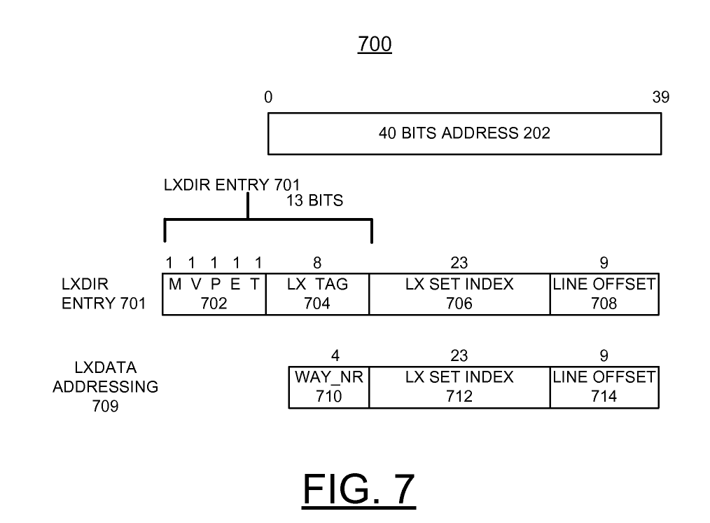

Mapping from a real address to the LXDIR 116 and LXDATA 118 is illustrated in FIG. 7.

Referring also to FIG. 7, there is shown an example relationship generally designated by the reference character 700 between real address and LXDIR 116 and LXDATA 118 in accordance with a preferred embodiment. The LX tag in the LXDIR entry 701 include the 5 control bits MVPET 702, and LX TAG 704 for a total of 13 bits, an LX Set index 706, and line offset 708. As shown, 23 bits of the real address indexes to one LXDIR set, the LX Set Index 706. LXDATA addressing 709 include a 4 bit way number 710, an LX Set index 712, and line offset 714. There are 16 CB(i) fields in a 16 way set. If one CB(i), LX TAG field 704 matches the tag portion of the request address (hit), then the cache line data may be accessed by setting WayN=i, and accessing LXDATA at the location <WayNr 710><LX Set Index 712><LineOffset 714>.

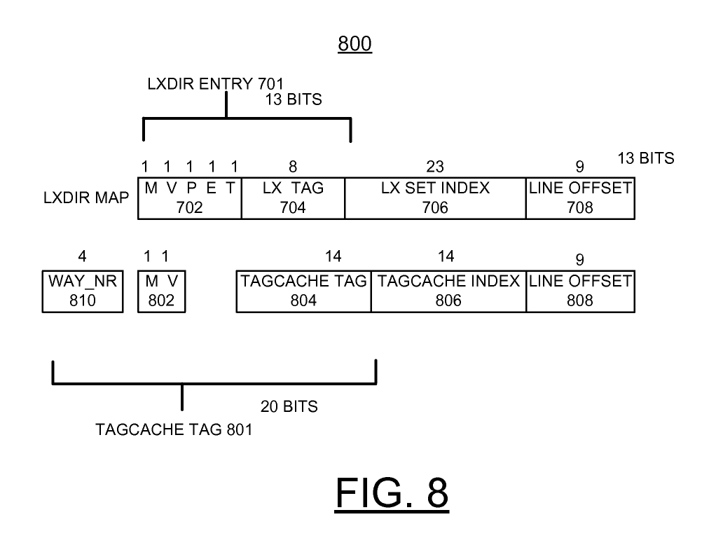

Referring also to FIG. 8, there is shown an example relationship generally designated by the reference character 800 between an LXDIR entry 701, as illustrated and described with respect to FIG. 7, and a tag cache entry 801 in accordance with a preferred embodiment. The LXDIR entry 701 is shown in relationship 800 with the tag cache entry 801 assumes a 4-way set associative tag cache 114 with a total of 512K entries. The tag cache 114 includes two control bits MV 802, and TAG CACHE TAG 804, a TAG CACHE index 806, and a line offset 808, and an n-way number 810. Multiple tag cache entries 801 defining the tag cache 114 provide the partial directory of the LX cache 112 for speeding up accesses to the LX cache 112. The TAG CACHE tag 801 tracks the state of one 512 B line in LX cache 112. Note the WayNr field 810 is included with the control bits M V 802, and the TAG CACHE TAG 804 form the tag cache entry 801.

When a memory request is made, the on-chip tag cache 112 is checked. If the tag cache request is a hit, then it is known that the address is also present in LX cache 112. The LX set index 706 is inferred from the least significant bits of the address. Since LX cache is a 16-way set associative cache, the requested address can be in any one of the 16 ways in the LX set. The WayNr field 810 of the tag cache entry 801 indicates the way number in LX cache 112 where the requested line is found. Thus, by concatenating the 4 bits WayNr field 310 with the LXDATA set index 806, the requested line's location may be found. Tag cache entry 801 contains Modified M and Valid V bits 802. The M bit 802 is used to indicate that the hit line was written in the past. The V bit 802 is used when the entry is invalidated, for example when the corresponding entry in LX cache 112 has been made invalid or evicted.

In addition, there are history bits or LRU tracking bits in each tag cache tag 804, such as the LRU bits 504 in the LXDIR set 501 to facilitate replacement of the tags, as illustrated in FIG. 5. The on-chip tag cache 114 operates at a much higher throughput than the LXDIR 116. Therefore it is desirable to operate the tag cache 114 as a write-back cache, where any change in the tag cache M bits 802 and LRU bits are not be reflected immediately to LXDIR 116 to save DRAM bandwidth. Only on tag cache 114 replacements that the corresponding LXDIR set may be updated to cut down on the LXDIR traffic. Only on tag cache misses and subsequent accesses to LXDIR 116 would reflect the M bit value in tag cache 114 to LXDIR 116. Only on tag cache misses and subsequent accesses to LXDIR 116 would reflect the LRU bits found in the tag cache 114 116 back to the LXDIR. Various LRU replacement policies and algorithms can be selected to minimize the LXDIR accesses. One proposed LX replacement policy uses a hybrid replacement policy where some lines which are also cached in tag cache 114 are marked as MRU lines, and during LX replacement, random replacement policy is used on the lines which are not present in the tag cache 114. Another possible replacement algorithm is to use a hybrid replacement algorithm, where an LX line is evicted randomly from 1 of 16 ways excluding those already found in the tag cache 114 as those are expected to be more recent.

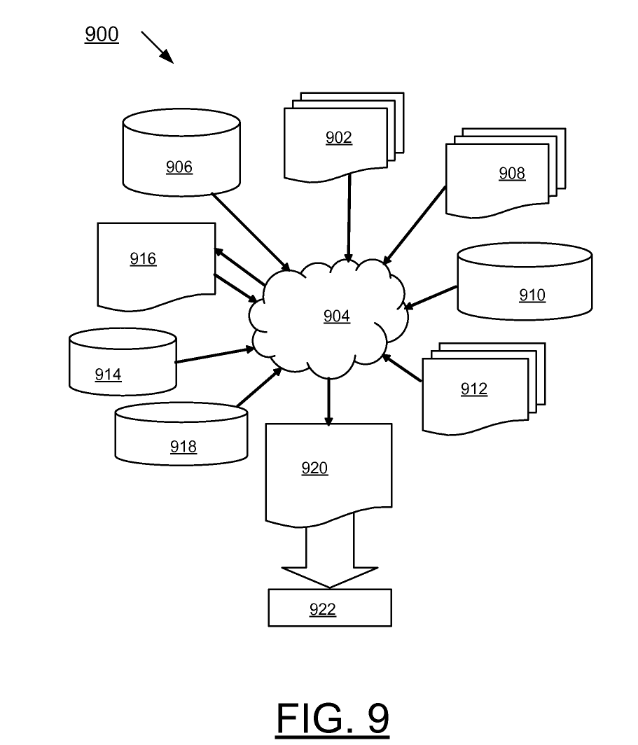

FIG. 9 shows a block diagram of an example design flow 900. Design flow 900 may vary depending on the type of IC being designed. For example, a design flow 900 for building an application specific IC (ASIC) may differ from a design flow 900 for designing a standard component. Design structure 902 is preferably an input to a design process 904 and may come from an IP provider, a core developer, or other design company or may be generated by the operator of the design flow, or from other sources. Design structure 902 comprises circuits 100, 106 in the form of schematics or HDL, a hardware-description language, for example, Verilog, VHDL, C, and the like. Design structure 902 may be contained on one or more machine readable medium. For example, design structure 902 may be a text file or a graphical representation of circuits 100, 106. Design process 904 preferably synthesizes, or translates, circuits 100, 106 into a netlist 906, where netlist 906 is, for example, a list of wires, transistors, logic gates, control circuits, I/O, models, etc. that describes the connections to other elements and circuits in an integrated circuit design and recorded on at least one of machine readable medium. This may be an iterative process in which netlist 906 is resynthesized one or more times depending on design specifications and parameters for the circuit.

Design process 904 may include using a variety of inputs; for example, inputs from library elements 908 which may house a set of commonly used elements, circuits, and devices, including models, layouts, and symbolic representations, for a given manufacturing technology, such as different technology nodes, 32 nm, 45 nm, 90 nm, and the like, design specifications 910, characterization data 912, verification data 914, design rules 916, and test data files 918, which may include test patterns and other testing information. Design process 904 may further include, for example, standard circuit design processes such as timing analysis, verification, design rule checking, place and route operations, and the like. One of ordinary skill in the art of integrated circuit design can appreciate the extent of possible electronic design automation tools and applications used in design process 904 without deviating from the scope and spirit of the invention. The design structure of the invention is not limited to any specific design flow.

Design process 904 preferably translates an embodiment of the invention as shown in FIGS. 1A, 1B, 2, 3, 4, 5, 6, 7, and 8 along with any additional integrated circuit design or data (if applicable), into a second design structure 920. Design structure 920 resides on a storage medium in a data format used for the exchange of layout data of integrated circuits, for example, information stored in a GDSII (GDS2), GL1, OASIS, or any other suitable format for storing such design structures. Design structure 920 may comprise information such as, for example, test data files, design content files, manufacturing data, layout parameters, wires, levels of metal, vias, shapes, data for routing through the manufacturing line, and any other data required by a semiconductor manufacturer to produce an embodiment of the invention as shown in FIGS. 1A, 1B, 2, 3, 4, 5, 6, 7, and 8. Design structure 920 may then proceed to a stage 922 where, for example, design structure 920 proceeds to tape-out, is released to manufacturing, is released to a mask house, is sent to another design house, is sent back to the customer, and the like.

While the present invention has been described with reference to the details of the embodiments of the invention shown in the drawing, these details are not intended to limit the scope of the invention as claimed in the appended claims.

What is claimed is:

1. A circuit for implementing efficient cache tag lookup in very large cache systems, said circuit comprising:
a large cache dynamic random access memory (DRAM);
a main large cache directory stored in said large cache DRAM;
cache data stored in said large cache DRAM;
a memory controller coupled to said large cache DRAM; and
a tag cache including a fast partial large cache directory maintained separately on chip in said memory controller; said tag cache storing most frequently accessed tags and containing predefined information enabling access to said cache data directly on tag cache hit with matching address and data present in said large cache.

2. The circuit as recited in claim 1 wherein said main large cache directory stored in said large cache DRAM is accessed to reach said cache data only on tag cache misses.

3. The circuit as recited in claim 1 wherein said large cache dynamic random access memory (DRAM) includes multiple DRAM GB (gigabytes), and said tag cache speeds up accesses to said large cache data, minimizing accesses to said main large cache directory stored in said large cache DRAM.

4. The circuit as recited in claim 1 wherein said large cache dynamic random access memory (DRAM) is used as fast front-end storage for a bulk DRAM storage.

5. The circuit as recited in claim 1 wherein said main large cache directory stored in said large cache DRAM has a tag array size significantly larger than said tag cache.

6. The circuit as recited in claim 1 wherein said tag cache includes in each entry an address tag and an n bit way number pointing to one of the 2**n-ways in said large cache data.

7. The circuit as recited in claim 6 wherein each said tag cache entry stores modified and valid control bits.

8. The circuit as recited in claim 1 wherein said tag cache and said main large cache directory are kept consistent with invalidations in said main large cache directory applied to said tag cache to invalidate a corresponding entry in said tag cache.

9. A design structure embodied in a non-transitory machine readable medium used in a design process, the design structure comprising:
a circuit tangibly embodied in the machine readable medium used in the design process, said circuit for implementing efficient cache tag lookup in very large cache systems, said circuit comprising:
a large cache dynamic random access memory (DRAM);
a main large cache directory stored in said large cache DRAM;
cache data stored in said large cache DRAM;
a memory controller coupled to said large cache DRAM; and
a tag cache including a fast partial large cache directory maintained separately on chip in said memory controller; said tag cache storing most frequently accessed tags and containing predefined information enabling access to said cache data directly on tag cache hit with matching address and data present in said large cache, wherein the design structure, when read and used in manufacture of a semiconductor chip produces a chip comprising said circuit.

10. The design structure of claim 9, wherein the design structure comprises a netlist, which describes said circuit.

11. The design structure of claim 9, wherein the design structure resides on storage medium as a data format used for exchange of layout data of integrated circuits.

12. The design structure of claim 9, wherein the design structure includes at least one of test data files, characterization data, verification data, or design specifications.

13. The design structure of claim 9, wherein said main large cache directory stored in said large cache DRAM is accessed to reach said cache data only on tag cache misses.

14. The design structure of claim 9, wherein said large cache dynamic random access memory (DRAM) includes multiple DRAM GB (gigabytes), and said tag cache speeds up accesses to said large cache data, minimizing accesses to said main large cache directory stored in said large cache DRAM.

15. The design structure of claim 9, wherein said main large cache directory stored in said large cache DRAM has a tag array size significantly larger than said tag cache.

16. The design structure of claim 9, wherein said tag cache includes in each entry an address tag, an n bit way number pointing to one of a plurality of n-ways in said large cache data, and modified and valid control bits.

17. The design structure of claim 9, wherein said tag cache and said main large cache directory are kept consistent with invalidations in said main large cache directory applied to said tag cache to invalidate a corresponding entry in said tag cache.

18. A method for implementing efficient cache tag lookup in very large cache systems including a large cache dynamic random access memory (DRAM), a large cache dynamic random access memory (DRAM); a main large cache directory stored in said large cache DRAM; and cache data stored in said large cache DRAM said method comprising:
providing a memory controller coupled to said large cache DRAM;
providing a tag cache including a fast partial large cache directory maintained separately on chip in said memory controller; and using said tag cache for:
storing most frequently accessed tags containing predefined information enabling access to said cache data directly on tag cache hit with matching address and data present in said large cache

19. The method as recited in claim 18 wherein storing most frequently accessed tags containing predefined information includes storing most frequently accessed tags containing an address tag, an n bit way number pointing to one of a plurality of n-ways in said large cache data, and modified and valid control bits.

20. The method as recited in claim 18 including accessing said main large cache directory stored in said large cache DRAM to reach said cache data only on tag cache misses.
